(19) United States
(12) Patent Application Publication
(10) Pub. No.: US 2026/0356117 A1
(43) Pub. Date: Nov. 12, 2026

(54) WRITING APPARATUS HAVING ROTATION-REVERSING STRUCTURE

(71) Applicant: Viktor Kuperman, Valley Village, CA (US)

(72) Inventor: Viktor Kuperman, Valley Village, CA (US)

(21) Appl. No.: 19/077,816

(22) Filed: Mar. 12, 2025

(51) Int. Cl. B43K 7/00; A63H 1/00; B43K 5/00; B43K 7/02; B43K 29/00

(52) U.S. Cl. CPC B43K 7/005; B43K 7/02; A63H 1/00; B43K 5/005; B43K 29/00

(57) ABSTRACT

A writing apparatus for writing from multiple writing tips and exhibiting a rotation-reversing behavior when spun atop a support surface includes a rattleback body which is shaped to frictionally engage the support surface such that, when spun in an initial rotational direction, kinetic energy from rotating the rattleback body causes an oscillatory rocking motion in the rattleback body which then causes a rotation of the rattleback body in a final rotational direction opposite the initial rotational direction. Ink cartridges are mounted to the rattleback body and positioned on opposing ends of the rattleback body. Different colors of ink may be used in the different ink cartridges. A display body may be mounted to the rattleback body such that an image, text, or other display materials are shown and made to spin at a rotational center of the rattleback body during the rotation-reversing behavior.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to writing implements and more particularly pertains to a new writing implement for writing from multiple writing tips and exhibiting a rotation-reversing behavior when spun atop a support surface.

### (2) Description of Related Art Including Information Disclosed Under 37 CFR 1.97 and 1.98

Writing implements have long been used as display devices in addition to their writing capabilities in order to advertise a brand or otherwise distribute a message, an image, or the like. However, the prior art fails to describe such an apparatus which may be used to draw attention by exhibiting a rotation-reversing behavior in which a shape and weight distribution of a body of the writing implement leads the writing implement to stop rotation in an initial rotational direction atop a support surface and rotate in a final rotational direction opposite the initial rotational direction. The prior art further fails to describe such an apparatus in which multiple ink cartridges may be used to draw further attention to the rotation-reversing behavior and a centrally positioned display body may be used to display matter which spins during the rotation-reversing behavior exhibited.

### (h) BRIEF SUMMARY OF THE INVENTION

An embodiment of the disclosure meets the needs presented above by generally comprising a rattleback body which is elongated between a first end and a second end and has a bottom surface which extends convexly arcuately between the first end and the second end. The rattleback body is configured via form and weight distribution to exhibit a rotation-reversing behavior. When the bottom surface is positioned atop a support surface and the rattleback body is rotated in a first rotational direction about a vertical axis which extends through the support surface, the rattleback body permits a continued rotation in the first rotational direction. The rattleback body will continue rotating in the first rotational direction until friction stops the rotation, another force stops the rotation, or other external forces cause a change in movement for the rattleback body. When the bottom surface is positioned atop the support surface and the rattleback body is rotated in a second rotational direction opposite the first rotational direction, the rattleback body is configured to interact with the support surface via friction and an induced oscillatory pitching motion to urge the rattleback body to rotate in the first rotational direction.

A first ink cartridge is mounted to the rattleback body and comprises a first chamber, a first head coupled to the first chamber, and a first writing tip coupled to the first head opposite the first chamber. The first writing tip is positioned adjacent to the first end of the rattleback body. A first ink is contained in the first chamber of the first ink cartridge and may be deposited onto a writing surface via the first writing tip. A second ink cartridge is mounted to the rattleback body and comprises a second chamber, a second head coupled to the second chamber, and a second writing tip coupled to the second head opposite the second chamber. The second writing tip is positioned adjacent to the second end of the rattleback body. A second ink is contained in the second chamber of the second ink cartridge and may be deposited onto the writing surface via the second writing tip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a writing apparatus according to an embodiment of the disclosure.

FIG. 2 is a side view of an embodiment of the disclosure.

FIG. 3 is a top in-use view of an embodiment of the disclosure which exhibits a motion of a rattleback body of the embodiment when a bottom surface of the rattleback body rests atop a support surface and the rattleback body is rotated in a first rotational direction. The rattleback body will continue to rotate in the first rotational direction, at least until friction stops the rotation or another external force acts upon the rattleback body.

FIG. 4 is a top in-use view of the embodiment of FIG. 3 in which exhibits a motion of the rattleback body of the embodiment when the bottom surface of the rattleback body rests atop the support surface and the rattleback body is rotated in a second rotational direction. The rattleback body will stop rotation in the second rotational direction and then rotate in the first rotational direction.

FIG. 5 is a top in-use view of an embodiment of the disclosure which exhibits a motion of a rattleback body of the embodiment when a top surface of the rattleback body rests atop a support surface and the rattleback body is rotated in a second rotational direction. The rattleback body will continue to rotate in the second rotational direction, at least until friction stops the rotation or another external force acts upon the rattleback body.

FIG. 6 is a top in-use view of the embodiment of FIG. 5 in which exhibits a motion of the rattleback body of the embodiment when the top surface of the rattleback body rests atop the support surface and the rattleback body is rotated in a first rotational direction. The rattleback body will stop rotation in the first rotational direction and then rotate in the second rotational direction.

### (j) DETAILED DESCRIPTION OF THE INVENTION

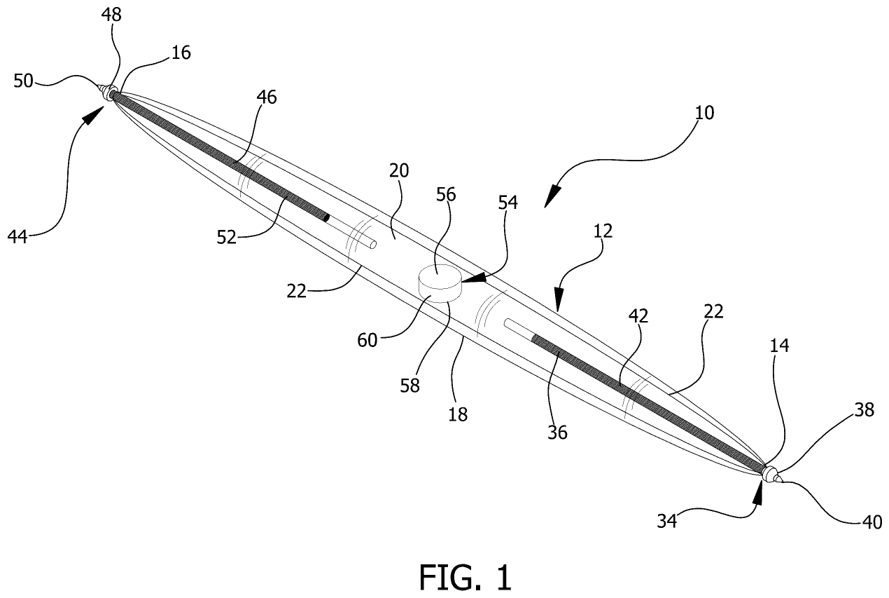

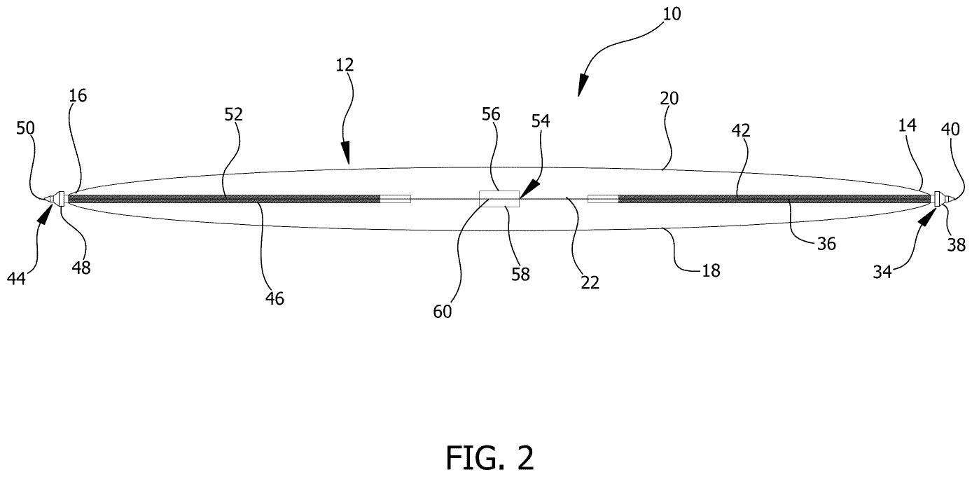

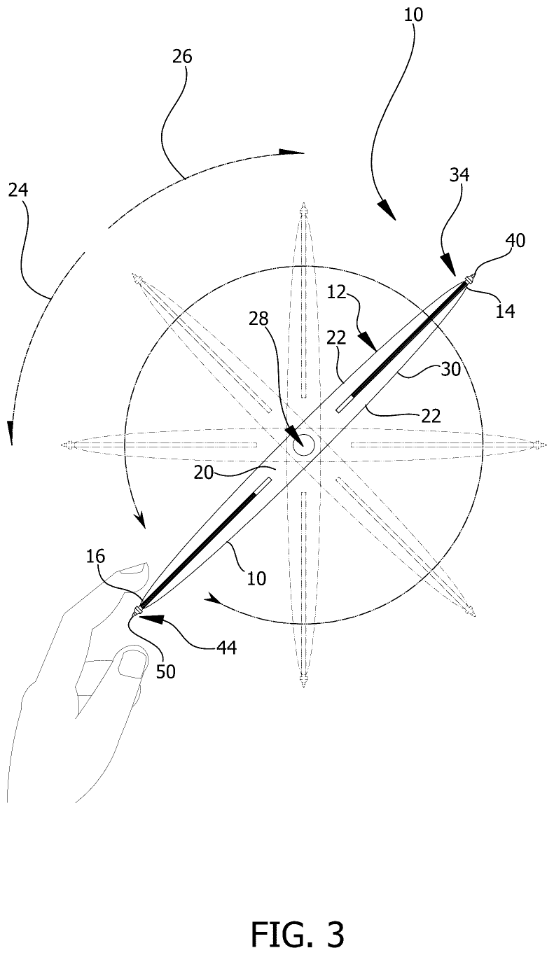

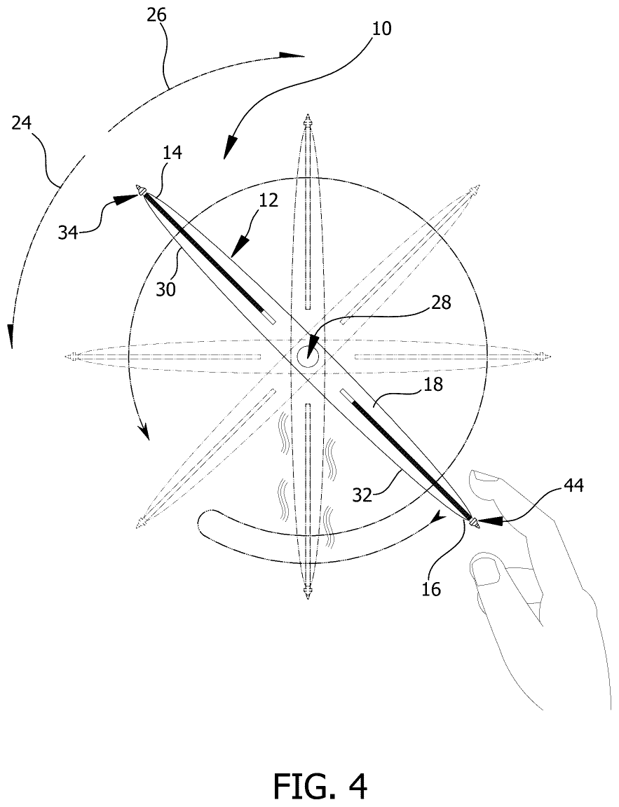

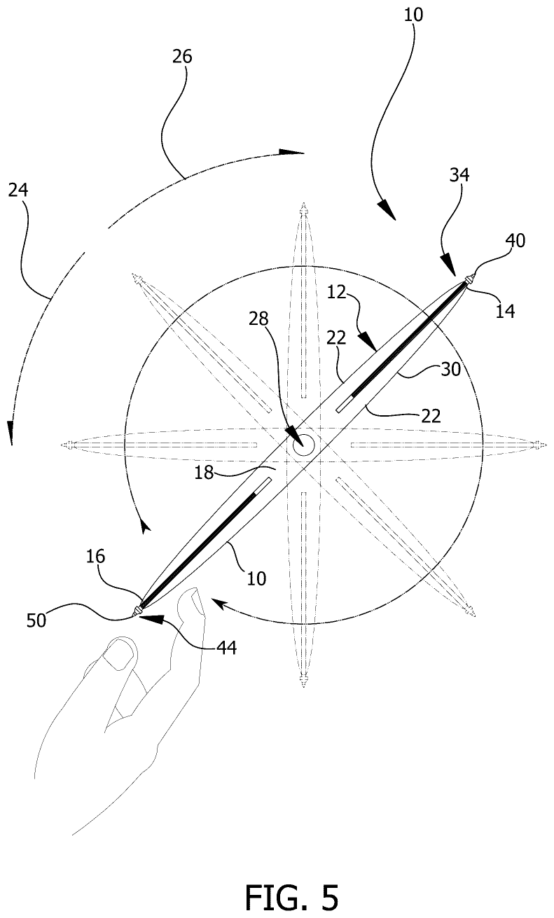

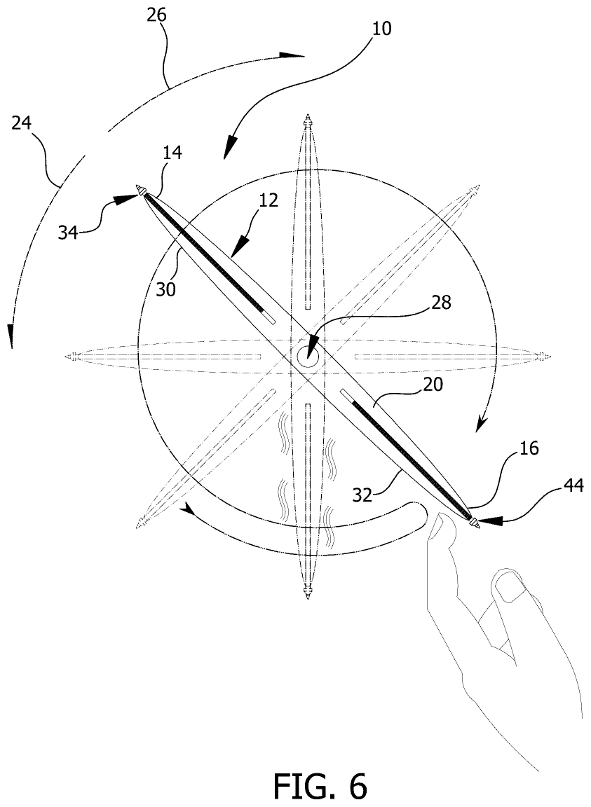

With reference now to the drawings, and in particular to FIGS. 1 through 6 thereof, a new writing implement embodying the principles and concepts of an embodiment of the disclosure and generally designated by the reference numeral 10 will be described.

As best illustrated in FIGS. 1 through 6, the writing apparatus 10 generally comprises a rattleback body 12 which is elongated between a first end 14 and a second end 16. The rattleback body 12 has a generally ellipsoidal shape. The rattleback body 12 may have apertures, recesses, protrusions, or other deformations that cause the rattleback body 12 to deviate from an ellipsoidal shape. In some embodiments, protrusions and similar deformations may be used particularly to enable or enhance a rotation-reversing behavior further described below. Additionally, the rattleback may have different shapes in other embodiments, but notably at least one surface which extends convexly arcuately between the first end 14 and the second end 16 of the rattleback body 12 or a similar structure is necessary for the rattleback body 12 to exhibit the rotation-reversing behavior.

A bottom surface 18 and a top surface 20 of the rattleback body 12 extend convexly arcuately between the first end 14 and the second end 16. The bottom surface 18 and the top surface 20 also extend convexly arcuately between a pair of lateral sides 22 of the rattleback body 12. The bottom surface 18 and the top surface 20 are curved such that they meet each other at the first end 14, the second end 16, and the lateral sides 22. The rattleback body 12 has a width of the rattleback body 12 between the lateral sides 22 is greater than a height of the rattleback body 12 between an uppermost point of the top surface 20 and a lowermost point of the bottom surface 18.

The rattleback body 12 is transparent such that an interior of the rattleback body 12 is viewable from outside of the rattleback body 12. As further described below, components are embedded or otherwise mounted in the rattleback body 12 and are viewable through the rattleback body 12. In other embodiments, the rattleback body 12 may be opaque, and the viewable components in the rattleback body 12 may be viewed through apertures extending into the rattleback body 12. Similarly, while the entirety of the rattleback body 12 is shown to be transparent, other embodiments may include only portions which are transparent such that the components housed within are only viewable from certain angles with respect to the rattleback body 12. The rattleback body 12 may include any suitable material which is sufficiently transparent for this purpose, such as glass, acrylic, polypropylene, or the like. “Transparent” is used in this disclosure to also refer to materials which are translucent, which is to say that light may travel through the materials but may diffract or otherwise cause distortions in viewing objects through the materials. The rattleback body 12 may be formed from a top member and a bottom member which are adhered or otherwise coupled together and which may sandwich the viewable components therebetween.

The rattleback body 12 is configured, via interactions between form, weight distribution, and friction to exhibit the rotation-reversing behavior as mentioned above and further described here. When the bottom surface 18 of the rattleback body 12 is positioned atop a support surface and the rattleback body 12 is rotated in a first rotational direction 24 about a vertical axis which extends through the support surface, the rattleback body 12 permits a continued rotation in the first rotational direction 24. Said another way, the rattleback body 12 will continue to rotate in the first rotational direction 24 when induced to do so until stopped by friction, stopped by another force, or otherwise acted upon to change its motion. However, when the bottom surface 18 is positioned atop the support surface and the rattleback body 12 is rotated in a second rotational direction 26 opposite the first rotational direction 24, the rattleback body 12 interacts with the support surface via friction and an induced oscillatory pitching motion to urge the rattleback body 12 to rotate in the first rotational direction 24.

The cause of the rotation-reversing behavior as described above will now be explained. As the rattleback body 12 is rotated in an initial rotational direction, the rattleback body 12 will have a first radial portion 30 which extends from a rotational center 28 of the rattleback body 12 to the first end 14 of the rattleback body 12 and a second radial portion 32 which extends from the rotational center 28 of the rattleback body 12 to the second end 16 of the rattleback body 12. When a contact portion of the bottom surface 18 in the first radial portion 30 leads a gravitational center of the first radial portion 30 around the rotational center 28 of the rattleback body 12, friction between the bottom surface 18 and the support surface will induce a rolling motion in the first radial portion 30 about a longitudinal axis of the rattleback body 12.

When this rolling motion is induced, the rotation of the rattleback body 12 is slowed to a greater extent than if the contact portion of the bottom surface 18 only slid along the support surface. Additionally, the rolling motion of the first radial portion 30 of the rattleback induces a pitching motion in the rattleback body 12 about a lateral axis which extends perpendicular to the longitudinal axis and through the lateral sides 22 of the rattleback body 12. In the pitching motion, part of the first radial portion 30 rises as the part tries to roll over the contact portion of the bottom surface 18, thus causing the rattleback body 12 to roll toward the second end 16 of the rattleback body 12. The second radial portion 32 will then also undergo a rolling motion which induces another pitching motion opposite the previous pitching motion.

A complex oscillation movement develops from these interactions in which (1) the first radial portion 30 rolls along the bottom surface 18 as it travels around the rotational center 28 of the rattleback body 12, (2) the rattleback body 12 pitches along the bottom surface 18 toward the second end 16 of the rattleback body 12, (3) the second radial portion 32 rolls along the bottom surface 18 as it travels around the rotational center 28 of the rattleback body 12, and (4) the rattleback body 12 pitches along the bottom surface 18 toward the first end 14 of the rattleback body 12. These steps are then repeated in a loop. Energy thus generally transfers from the rotational momentum of the rattleback body 12 around the vertical axis into the induced oscillatory pitching motion in which the rattleback body 12 rocks toward the second end 16 of the rattleback body 12, then toward the first end 14 of the rattleback body 12, and so on.

After all the rotational momentum of the rattleback body 12 is depleted, the induced oscillatory pitching motion then operates to cause a rotation in a final rotational direction opposite the initial rotational direction. This is because, as the rattleback body 12 rocks such that the first radial portion 30 engages the support surface, the gravitational center of the first radial portion 30 is offset from the contact portion of the bottom surface 18 such that the first radial portion 30 will be induced to roll in an opposite direction to its previous rolling motion. Another complex oscillation movement develops in which the first radial portion 30 and the second radial portion 32 alternate rolling to induce the rattleback body 12 to rotate in the final rotational direction.

The rattleback body 12 will rotate in the final rotational direction until stopped by friction, stopped by other forces, or otherwise caused to change its movement. For the purposes of achieving the rotation-reversing behavior, the initial rotational direction would be selected to correspond to the second rotational direction 26 of the rattleback body 12 of the present invention. The final rotational direction would therefore correspond to the first rotational direction 24 of the rattleback body 12.

The rattleback body 12 must therefore have a weight distribution such that the motion described occurs. The density of the rattleback body 12 may be chosen to offset the gravitational centers of the first radial portion 30 and the second radial portion 32 from the portions of the bottom surface 18 in each of the first radial portion 30 and the second radial portion 32 in the second rotational direction 26. In some embodiments, weights made from different materials may be placed in the rattleback body 12 or hollows may be formed to distribute the weight of the rattleback body 12 accordingly. In some embodiments, the shape of the rattleback body 12 may deviate from an ellipsoid such that the portions of the bottom surface 18 on each of the first radial portion 30 and the second radial portion 32 are offset from the gravitational centers accordingly.

The rattleback body 12 is also configured to exhibit a similar behavior when the top surface 20 of the rattleback body 12 is positioned atop the support surface. When the top surface 20 is positioned atop the support surface and the rattleback body 12 is rotated in the second rotational direction 26, the rattleback body 12 permits a continued rotation in the second rotational direction 26. When the top surface 20 is positioned atop the support surface and the rattleback body 12 is rotated in the first rotational direction 24, the rattleback body 12 interacts with the support surface via friction and the induced oscillatory pitching motion to urge the rattleback body 12 to rotate in the second rotational axis. The weight distribution of the rattleback body 12 is distributed to facilitate the rotation-reversing behavior as further described above.

A first ink cartridge 34 is mounted in the rattleback body 12 and extends out of the rattleback body 12 through the first end 14. The first ink cartridge 34 comprises a first chamber 36 positioned in the rattleback body 12, a first head 38 coupled to the first chamber 36, and a first writing tip 40 coupled to the first head 38 opposite the first chamber 36. The first writing tip 40 and the first head 38 are positioned outside of the rattleback body 12. The first chamber 36 is transparent such that an interior of the first chamber 36 is viewable from outside of the first chamber 36. The first chamber 36 is elongated and extends along a longitudinal axis of the rattleback body 12. The first writing tip 40 comprises a ball-type tip in which a spherical member secured in a socket of the head is permitted to roll across a writing surface to distribute ink onto the writing surface. The first writing tip 40 also may comprise a felt tip, a brush, a nib, or the like. A first ink 42 is contained in the first chamber 36 of the first ink cartridge 34, and the first writing tip 40 is configured to deposit the first ink 42 onto the writing surface.

A second ink cartridge 44 is mounted in the rattleback body 12 and extends out of the rattleback body 12 through the second end 16. The second ink cartridge 44 comprises a second chamber 46 positioned in the rattleback body 12, a second head 48 coupled to the second chamber 46, and a second writing tip 50 coupled to the second head 48 opposite the second chamber 46. The second writing tip 50 and the second head 48 are positioned outside of the rattleback body 12. The second chamber 46 is transparent such that an interior of the second chamber 46 is viewable from outside of the second chamber 46. The second chamber 46 is elongated and extends along a longitudinal axis of the rattleback body 12. The second writing tip 50 comprises a ball-type tip but may comprise a felt tip, a brush, a nib, or the like. A second ink 52 is contained in the second chamber 46 of the second ink cartridge 44, and the second writing tip 50 is configured to deposit the second ink 52 onto the writing surface.

The first chamber 36 and the second chamber 46 may comprise any suitably transparent material such as acrylic, polypropylene, glass, or the like. The first ink 42 has a first color and the second ink 52 has a second color. For example, the first ink 42 may be red, while the second ink 52 is blue. The first ink 42 and the second ink 52 are viewable through the rattleback body 12 and the respective one of the first chamber 36 and the second chamber 46.

A display body 54 is mounted in the rattleback body 12 and is configured to be positioned at the rotational center 28 of the rattleback body 12. The display body 54 has an upper surface 56 which faces upwardly with respect to the rattleback body 12 and a lower surface 58 which faces downwardly with respect to the rattleback body 12. The upper surface 56 and the lower surface 58 have planar shapes, and a perimeter surface 60 of the display body 54 extends from the upper surface 56 to the lower surface 58. The perimeter surface 60 has a cylindrical shape but may have a polygonal prism shape or other suitable shape. The upper surface 56 and the lower surface 58 of the display body 54 may include display indicia which is viewable through the rattleback body 12.

Display indicia may include graphical images, alphanumeric characters, symbols, textural features, or the like. The display body 54 may also take on other shapes suitable for showing the display indicia upwardly and downwardly respectively relative to the rattleback body 12.

In use, the rattleback body 12 may be spun to exhibit the rotation-reversing behavior described above. The display indicia may include logos, advertisements, or other messages to be displayed on the upper surface 56 and the lower surface 58 of the display body 54. The rotation-reversing behavior may be used to draw attention to the display indicia, and the display indicia may be designed such that a movement of the display indicia as caused by the rotation-reversing behavior of the rattleback body 12 draws further attention to the display indicia or causes effects when perceived by a viewer.

The first ink cartridge 34 may be used to deposit the first ink 42 onto the writing surface, and the second ink cartridge 44 may be used to deposit the second ink 52 onto the writing surface. The first ink 42 and the second ink 52 may be viewed through the rattleback body 12 and the respective one of the first chamber 36 and the second chamber 46. By viewing the first ink 42 and the second ink 52, the viewer may ascertain whether or not the writing apparatus 10 may be used to write on the writing surface. The first ink 42 and the second ink 52 also draw attention to different sections of the rattleback body 12, highlighting the rotation-reversing behavior exhibited by the rattleback body 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A writing apparatus comprising:
a rattleback body, the rattleback body being elongated between a first end and a second end, a bottom surface of the rattleback body extending convexly arcuately between the first end and the second end;
wherein the rattleback body is configured to:
when the bottom surface is positioned atop a support surface and the rattleback body is rotated in a first rotational direction about a vertical axis extending through the support surface, permit a continued rotation in the first rotational direction; and
when the bottom surface is positioned atop the support surface and the rattleback body is rotated in a second rotational direction opposite the first rotational direction, urge the rattleback body to rotate in the first rotational direction via an induced oscillatory pitching motion about a lateral axis extending between a pair of lateral sides of the rattleback body;
a first ink cartridge mounted to the rattleback body, the first ink cartridge comprising a first chamber, a first head coupled to the first chamber, and a first writing tip coupled to the first head opposite the first chamber, the first writing tip being positioned adjacent to the first end of the rattleback body;
a first ink contained in the first chamber of the first ink cartridge, the first writing tip being configured to deposit the first ink onto a writing surface;
a second ink cartridge mounted to the rattleback body, the second ink cartridge comprising a second chamber, a second head coupled to the second chamber, and a second writing tip coupled to the second head opposite the second chamber, the second writing tip being positioned adjacent to the second end of the rattleback body; and
a second ink contained in the second chamber of the second ink cartridge, the second writing tip being configured to deposit the second ink onto the writing surface.

2. The writing apparatus of claim 1, further comprising a display body mounted to the rattleback body, the display body having an upper surface which faces upwardly with respect to the rattleback body, the upper surface being viewable from above the rattleback body, the upper surface being configured to include display indicia, the display body being configured to be positioned at a rotational center of the rattleback body.

3. The writing apparatus of claim 1, wherein:
a top surface of the rattleback body extending convexly arcuately between the first end and the second end; and
the rattleback body is configured to:
when the top surface is positioned atop the support surface and the rattleback body is rotated in the second rotational direction, permit a continued rotation in the second rotational direction; and
when the top surface is positioned atop the support surface and the rattleback body is rotated in the first rotational direction, urge the rattleback body to rotate in the second rotational direction via the induced oscillatory pitching motion about the lateral axis.

4. The writing apparatus of claim 3, further comprising a display body mounted in the rattleback body, the display body having an upper surface which faces upwardly with respect to the rattleback body, the upper surface being viewable from above the rattleback body, the display body having a lower surface with respect to the rattleback body, the lower surface being viewable from below the rattleback body, the upper surface and the lower surface being configured to include display indicia, the display body being configured to be positioned at a rotational center of the rattleback body.

5. The writing apparatus of claim 4, wherein:
the rattleback body is transparent such that an interior of the rattleback body is viewable from outside of the rattleback body; and
the display body is mounted in the rattleback body, the display body being viewable through the rattleback body.

6. The writing apparatus of claim 3, wherein the bottom surface of the rattleback body extends convexly arcuately between the pair of lateral sides of the rattleback body, the top surface of the rattleback body extending convexly arcuately between the pair of lateral sides, the rattleback body having a generally ellipsoidal shape.

7. The writing apparatus of claim 1, wherein the first ink has a first color, the second ink having a second color different than the first color.

8. The writing apparatus of claim 1, wherein:
the rattleback body is transparent such that an interior of the rattleback body is viewable from outside of the rattleback body;
the first ink cartridge is mounted in the rattleback body and extends out of the rattleback body through the first end, the first chamber being positioned in the rattleback body, the first writing tip and the first head being positioned outside of the rattleback body, the first chamber being transparent such that the first ink is viewable from outside of the first chamber;
the first ink cartridge is mounted in the rattleback body and extends out of the rattleback body through the first end, the first chamber being positioned in the rattleback body, the first writing tip and the first head being positioned outside of the rattleback body, the first chamber being transparent such that the first ink is viewable from outside of the first chamber;
the second ink cartridge is mounted in the rattleback body and extends out of the rattleback body through the second end, the second chamber being positioned in the rattleback body, the second writing tip and the second head being positioned outside of the rattleback body, the second chamber being transparent such that the second ink is viewable from outside of the second chamber; and
the second ink cartridge is mounted in the rattleback body and extends out of the rattleback body through the second end, the second chamber being positioned in the rattleback body, the second writing tip and the second head being positioned outside of the rattleback body, the second chamber being transparent such that the second ink is viewable from outside of the second chamber.

9. The writing apparatus of claim 8, wherein the first ink has a first color, the second ink having a second color different than the first color.

10. The writing apparatus of claim 8, wherein:
the first chamber is elongated and extends along a longitudinal axis of the rattleback body; and
the second chamber is elongated and extends along a longitudinal axis of the rattleback body.

11. The writing apparatus of claim 1, wherein the first writing tip and the second writing tip comprise ball-type tips.

12. A writing apparatus comprising:
a rattleback body, the rattleback body being elongated between a first end and a second end, a bottom surface of the rattleback body extending convexly arcuately between the first end and the second end, the bottom surface extending convexly arcuately between a pair of lateral sides of the rattleback body, a top surface of the rattleback body extending convexly arcuately between the first end and the second end, the top surface extending convexly arcuately between the pair of lateral sides, the rattleback body having a generally ellipsoidal shape, the rattleback body being transparent such that an interior of the rattleback body is viewable from outside of the rattleback body;
wherein the rattleback body is configured to:
when the bottom surface is positioned atop a support surface and the rattleback body is rotated in a first rotational direction about a vertical axis extending through the support surface, permit a continued rotation in the first rotational direction;
when the bottom surface is positioned atop the support surface and the rattleback body is rotated in a second rotational direction opposite the first rotational direction, urge the rattleback body to rotate in the first rotational direction via an induced oscillatory pitching motion about a lateral axis extending between the pair of lateral sides of the rattleback body;
when the top surface is positioned atop the support surface and the rattleback body is rotated in the second rotational direction, permit a continued rotation in the second rotational direction; and
when the top surface is positioned atop the support surface and the rattleback body is rotated in the first rotational direction, urge the rattleback body to rotate in the second rotational direction via the induced oscillatory pitching motion about the lateral axis;
a first ink cartridge mounted in the rattleback body and extending out of the rattleback body through the first end, the first ink cartridge comprising a first chamber positioned in the rattleback body, a first head coupled to the first chamber, and a first writing tip coupled to the first head opposite the first chamber, the first writing tip and the first head being positioned outside of the rattleback body, the first chamber being transparent such that an interior of the first chamber is viewable from outside of the first chamber, the first chamber being elongated and extending along a longitudinal axis of the rattleback body, the first writing tip comprising a ball-type tip;
a first ink contained in the first chamber of the first ink cartridge, the first writing tip being configured to deposit the first ink onto a writing surface, the first ink having a first color;
a second ink cartridge mounted in the rattleback body and extending out of the rattleback body through the second end, the second ink cartridge comprising a second chamber positioned in the rattleback body, a second head coupled to the second chamber, and a second writing tip coupled to the second head opposite the second chamber, the second writing tip and the second head being positioned outside of the rattleback body, the second chamber being transparent such that an interior of the second chamber is viewable from outside of the second chamber, the second chamber being elongated and extending along the longitudinal axis of the rattleback body, the second writing tip comprising a ball-type tip;
a second ink contained in the second chamber of the second ink cartridge, the second writing tip being configured to deposit the second ink onto the writing surface, the second ink having a second color different than the first color; and
a display body mounted in the rattleback body, the display body being configured to be positioned at a rotational center of the rattleback body, the display body having an upper surface which faces upwardly with respect to the rattleback body, the display body having a lower surface which faces downwardly with respect to the rattleback body, the upper surface and the lower surface being configured to include display indicia, the upper surface and the lower surface having planar shapes, the display body having a perimeter surface which extends from the upper surface to the lower surface, the perimeter surface having a cylindrical shape.
